(19) United States
(12) Patent Application Publication
(10) Pub. No.: US 2021/0225163 A1
(43) Pub. Date: Jul. 22, 2021

(54) WRONG-WAY DRIVING DETECTION & PREVENTION WITH ROADSIDE ASSISTANCE

(71) Applicants: NERMIN MASLAR, Peoria, AZ (US); Awais Agha, Glendale, AZ (US); Robert King, Milford, OH (US)

(72) Inventors: NERMIN MASLAR, Peoria, AZ (US); Awais Agha, Glendale, AZ (US); Robert King, Milford, OH (US)

(21) Appl. No.: 16/899,247

(22) Filed: Jun. 11, 2020

Related U.S. Application Data
(60) Provisional application No. 62/860,526, filed on Jun. 12, 2019.

(51) Int. Cl. G08G 1/04; G08G 1/017; G07C 5/00; G07C 5/08; G08G 1/056; G08G 1/0967; B60R 16/023; B60W 10/06; B60W 10/18; B60W 30/18; B60W 50/14

(52) U.S. Cl. CPC G08G 1/04; G08G 1/0175; G07C 5/008; G07C 5/0841; G08G 1/056; B60W 50/14; G08G 1/096783; B60R 16/023; B60W 10/06; B60W 10/18; B60W 30/18009; G08G 1/096725

(57) ABSTRACT

A device, method, and system may remotely monitor and control one or more subsystems in a terrestrial vehicle. In one embodiment, stakeholders, law enforcement entities, government agencies, and national security organizations may access the reported data. In one embodiment, a modular device may monitor vehicle subsystems, vehicle environmental data, RPM, speed, tire pressure, fuel level and usage, mileage, date and time, repair history, log book, VIN, driver's ID data.

### CROSS-REFERENCE TO RELATED APPLICATIONS

This nonprovisional utility patent application claims the benefit of a prior-filed provisional patent application under 35 U.S.C. 119(e) and presents the reference to the earlier application in the attached application data sheet.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX Not Applicable

### BACKGROUND OF THE INVENTION

On estimate, more than 300 people in the United States die in traffic accidents caused by drivers headed to ‘wrong-way’ traffic, either intentionally or inadvertently, where freeway ramps are the main entry points for most recorded wrong-way crashes.

Efforts to alert drivers and law enforcement agencies for reducing wrong-way crashes have been placed including several different types of overhead and roadside signage as well as leveraging advance technology including road and directional motion sensors, magnetic and induction-based sensors, radar-based monitoring and video image processing.

### BRIEF SUMMARY OF THE INVENTION

Wrong-way Driving Detection & Prevention with Roadside Assistance [WWDDPRA] leverage artificial intelligence and advance sensing technology to not only alert the driver and concerned authority but also controls the vehicle to stop safely before entering into the wrong-way traffic.

Because of its ability to take real-time event-based actions without any human interaction, reduces the chance of wrong-way crashes minimum to 0%.

There are two core parts of the WWDDPRA, Master Traffic Control Unit [MTCU] mounted on the ground and Vehicle Communication Unit [VCU] attach to Vehicle's Engine Control Module [ECM] through OBD/OBDII port. MTCU detects when the vehicle enters into the entrance or exit of the intersection or a highway ramp and signals VCU which communicate with ECM to take no action if the vehicle is moving in the right direction or alert the driver and eventually slow the vehicle to a complete stop if it detected moving in the wrong direction.

If MTCU detects wrong-way driving vehicle and cannot communicate with VCU, it alerts the concern authorities of wrong-way driver with location, time, picture and short video of the incident.

### BRIEF DESCRIPTION OF THE SEVERAL VIEWS OF THE DRAWING

Example embodiments are illustrated by way of example and not limitation in the figures of accompanying drawings, in which like references indicate similar elements and in which:

FIG. 1 is a block diagram illustrating the Master Traffic Control Unit MTCU comprising its subsystem.

FIG. 2 is a block diagram illustrating the Vehicle Control Unit VCU comprising its elements.

FIG. 3 is a Flow diagram illustrating the functions and steps performed by MTCU, its subsystem and VCU upon detecting vehicle motion.

### DETAILED DESCRIPTION OF THE INVENTION

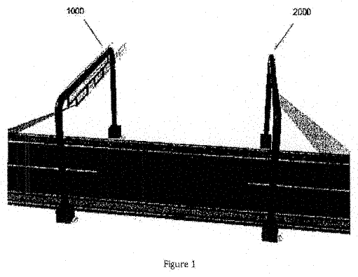

In the embodiment of FIG. 1, the device 1000 may comprise microprocessor based system which may comprise of a central processing unit, data storage unit (e.g. Hard Drive), stationary transceivers may be part of a cellular radio network (e.g. GSM, HSPA+, CDMA, EVDO, WiMax, LTE), a satellite radio network (e.g. non-terrestrial microwave network), or another electromagnetic network (e.g. Wifi, IEEE 802.11, Bluetooth), or wired communication unit (e.g. Ethernet, Fiber Optics).

The device 1000 may also interact with and accept data from one or more location sensors, one or more speed sensors, one or more temperature sensors, to process and store into the data storage unit.

The device 1000 may also interact and accept video and image data from one or more devices (e.g. digital camera, video camera, thermal camera), to process and store into the data storage unit. The image data may comprise a barcode or a picture of the License Plate of the vehicle.

The device 1000 may also interact and accept audio data from one or more devices (e.g. microphones).

The device 1000 analyzes the directional data captured from video and image devices, along with the data accepted from speed sensors.

The device 2000 consists of additional sensors and communication protocols and may be used for long-range coverage.

The device 1000 may also interact and accept data from Vehicle Control Unit VCU, when VCU is detected inside the vehicle. Whereas the detection can be done using the Barcode, Radio-Frequency Identification RDIF, Bluetooth, Wi-Fi, or other analog radio transceivers. Upon detection of the VCU, the device 1000 establishes wireless connection with the VCU by use of a wireless communication unit comprising 100, 101, 105, 109 to retrieve required data comprising: Vehicle ID Number VIN, Contact details of the Owner and Manager, Engine configuration, Speed, RPM, Tire pressure, Fuel level etc.

No further action is taken when the vehicle's direction of motion is detected in the correct way.

If/When the device 1000 detects the vehicle's direction in wrong way, the warning signals issue to the driver of the vehicle, owner, manager and law enforcement agencies; the warning comprising an audible notification to driver using VCU, flashing lights at the device 1000 and the device 2000; and the notification comprising Vehicle ID, Driver ID, Location, Date and Time, Picture of the vehicle, and video of the incident will be sent to law enforcement agencies like local police, Highway Patrol, Ambulances, Firefighters and others.

If/When vehicle continues in the wrong direction, the Device 1000 issues the distress signal to the Device 2000, which issues a set of commands to the VCU, comprising: shutting down fuel supply to the engine, applying brakes, locking the ECM, to bring the vehicle to a safe stop.

The device 1000 creates frequent backups of stored and processed data into the Central Data Center CDC.

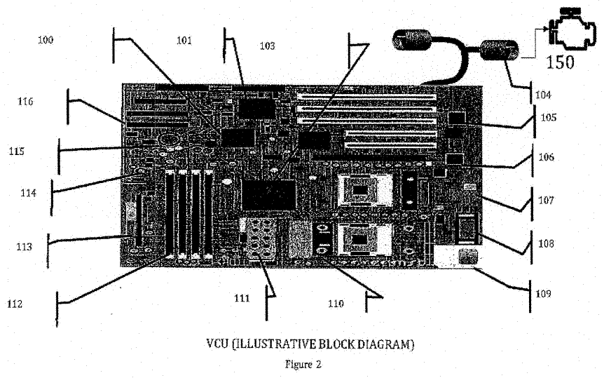

In the embodiment of FIG. 2, the device may comprise a Micro Processor (103) for computations. The other elements 100, 101, 105, 109 the stationary transceivers may be part of a cellular radio network (e.g. GSM, HSPA+, CDMA, EVDO, WiMax, LTE), a satellite radio network (e.g. non-terrestrial microwave network), or another electromagnetic network (e.g. Wi-Fi, IEEE 802.11, Bluetooth). These components are used for communication between the peripherals and/or communication protocols for Owner, Operator, Manager, Technician, Engineer and Law Enforcement and Ambulatory agencies; and/or provide the communication protocols between the devices 1000 and 2000.

In the embodiment of FIG. 2, the device may be configured to communicate with an Engine Control Module (ECM) using On-Board Diagnostic port 150 that is communicatively coupled and configured to host and process the collected data.

In the embodiment of FIG. 2, The component 106 enables the display when/if needed; Universal Serial Bus ports 107 may be used for connecting additional I/O devices; 108 the Power switch, may also be used for resetting the device; a data storage unit 110 stores raw and processed data in real-time; The component 111 establishes two-way connection with vehicle's ECM; 112 indicator lights; Power Supply port 113; Random Access Memory 114 to facilitate central processing unit; The component 115 may comprising Location sensor, speed sensor; 116 speaker and mic may be used for direct communication with driver, providing alerts and notifications, recording cockpit voice;

In the embodiment of FIG. 2, The elements 100, 101, 105, 109 may also be used for transferring data to CDC for using secured and encrypted communication protocol;

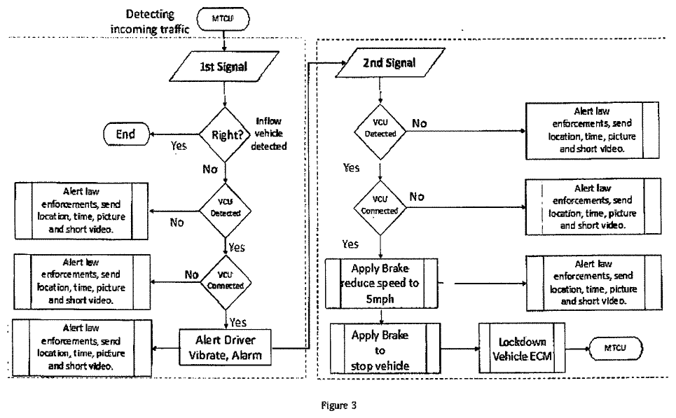

In the embodiment of FIG. 3, comprising the data flow diagram, representing steps and actions performed by devices 1000, 2000 and VCU;

In the embodiment of FIG. 4, comprising raw and processed data being stored at 110.

We claim:

1. A Master Traffic Control Unit (MTCU) wirelessly communicating with terrestrial vehicle's Engine Control Module (ECM) through a stationary micro-processing unit called Vehicle Control Unit (VCU), adapted for installation inside the vehicle, whereas MTCU can be installed on the ground or on a portable platform by the road; MTCU comprising:
a central processing unit, programmed to process data captured from components further comprising of:
a data storage unit, adapted to store operating data and the data processed by central processing unit;
an image and video capturing unit comprising digital camera, connected wirelessly or through wire, adapted to communicate with central processing unit for processing and storing in data storage unit;
a voice sensing unit, adapted to communicate audio data with central processing unit for processing and storing in data storage unit;
a location sensor, wherein the location sensor is adapted to communicate location data with central processing unit and data storage unit;
a motion sensing unit, adapted to detect motion and directional data and communicate the collected data to central processing unit for processing and storing in data storage unit;
a speed sensor unit, adapted to detect vehicle speed and communicate the collected data to central processing unit for processing and storing in data storage unit;
a secured and encrypted wireless communication protocol unit to communicate with VCU inside the vehicle;

2. MTCU of claim 1, further comprising of secured and encrypted wireless protocol to communicate with Central Data Center CDC, to offload processed data from data storage unit on regular intervals;

3. MTCU of claim 1, further comprising of communication protocol to send alerts and collected data to at least one of: a law enforcement entity, a government agency and or a national security agency

4. A subsystem comprising of secondary stationary communication unit, controlled by central processing unit, comprising of:
a secured wired communication protocol, communicating with central processing unit;
a secondary wireless communication protocol unit to communicate with VCU;
a secondary speed sensor unit communicating with central processing unit;
a secondary image and video capturing unit communicating with central processing unit;
a secondary voice sensing circuit communicating with central processing unit;

5. A stationary micro processing unit called Vehicle Control unit VCU installed inside the vehicle and connected to vehicle's ECM using wired or wireless protocols, comprising hard wire, Wi-Fi, Bluetooth, Peer-to-Peer;

6. The system of claim 5, further comprising:
a central processing unit, programmed to process and store data captured from components further comprising of:
a data storage unit, adapted to store operating data and the data processed by central processing unit;
a location sensor, wherein the location sensor communicates location data of the vehicle to the central processing unit;
a speed sensor unit, adapted to detect vehicle speed and communicate the collected data to central processing;

7. The system of claim 5, further comprising a protocol converter, wherein the protocol converter is adapted to communicate with vehicle's ECM to collect vehicle's sensors data;

8. The system of claim 5, further comprising a secondary protocol converter, wherein the secondary protocol converter is adapted to establish two way communication between VCU and ECM;

9. The system of claim 5, further comprising of secured and encrypted wireless protocol to communicate with Central Data Center CDC, to offload processed data from data storage unit on regular intervals;

10. A method of remotely monitoring and controlling a terrestrial vehicle, the method comprising:
Accepting and processing commands from VCU, and providing data and feedback back to VCU for further processing and storing;
Whereas the commands can be processed comprising: automatically by central processing unit, VCU, MTCU, CDC, Managers, Technicians, Engineers, support staff, Law enforcement agencies, Police, Department of Transportation DOT, Highway Patrol, using wired and wireless protocols;

11. The method of claim 10, further comprising commands for:
Vehicle Identification Number VIN and comprising other identifiers;
Status and data collected from sensors present inside the vehicle;
Reading existing and all historical fault codes and storing;
Current and historical Emission data processing and storing;
Current and historical speed data processing and storing;
Current and historical location data processing and storing;
Current and historical tire-pressure data processing and storing;
Current and historical fuel usage data processing and storing;
Current and historical idle time data processing and storing;
Current and historical vehicle speed data processing and storing;
Current and historical engine RPM data processing and storing;
Comparing, the collected data with thresholds data; processing, storing and communicating the raw and process data for maintenance procedures of the vehicle;
Push notifications, of processed and raw data to authorized users;
Diagnosing, troubleshooting, Reprogramming, Resetting vehicle sensors and other components, comprising: speed, RPM, fuel, transmission, emission, brakes, lighting, radio, cooling system, fault codes;

12. The method of claim 10, further comprising:
Accepting distress signal from authorized entities using secured and encrypted protocol, comprising VCU, MTCU, CDC, Managers, Technicians, Engineers, support staff, Law enforcement agencies, Police, Department of Transportation DOT, Highway Patrol;
Take actions guided by distress signals, comprising:
Shutting fuel supply;
Controlling RPM;
Controlling Brakes;
Applying emergency protocols;
Establishing audio/video communication with driver of the vehicle.
